(19) United States
(12) Patent Application Publication
(10) Pub. No.: US 2004/0010424 A1
(43) Pub. Date: Jan. 15, 2004

(54) System for establishing and controlling e-commerce web applications for the sale of health foods, nutriceuticals and vitamins

(76) Inventor: Peter Klein, Bethany, CT (US)

Correspondence Address: NATIONAL IP RIGHTS CENTER, LLC, SCOTT J. FIELDS, ESQ., 550 TOWNSHIP LINE ROAD, SUITE 400, BLUE BELL, PA, 19422, US

(21) Appl. No.: 10/194,953

(22) Filed: Jul. 12, 2002

(51) Int. Cl. G06F 17/60

(52) U.S. Cl. 705/3

(57) ABSTRACT

A method for providing an end user patient with the ability to purchase health foods and the like pre-approved by the health care provider comprising the following steps: (a) providing a website comprising a virtual storefront created and populated by a health care provider whereby the patient can select and order health related non-prescription ingestibles; (b) facilitating the payment of the ingestibles by the patient according to payment options selected by the health care provider; and (c) facilitating the delivery of the ingestibles to the end user patient according to payment options selected by the health care provider.

### Field of the Invention

The present invention is directed to a method for selling products. In particular, the present invention is directed to a novel method for selling health goods and related products such as health food, vitamins and nutriceuticals. The present invention is specifically directed to a method for selling health related products over the Internet.

### BACKGROUND OF THE INVENTION

Currently, there are a number of instrumentalities for the sale of various types of health care and nutritional products. These products are typically sold in stores such as GNC and the like. In addition, there are a number of e-commerce based websites related to the sale of various health related products, goods, nutriceuticals and the like, including ultimate like nutriceuticals.

While there have been a number of ecommerce applications, it has been difficult for physicians, chiropractors, fitness trainers and the like to recommend such products and to sell them to their patients.

Heretofore, there has not been a simple and easy implementation mechanism for enabling chiropractors, physicians, personal trainers and the like to sell health foods, vitamins, nutriceuticals and the like via a novel business model and website configuration.

It is a principal object of the present invention to provide a system whereby medical practitioners, chiropractors, health care providers and the like.

It is a particular object of the present invention to provide a system whereby such professionals can set up individualized e-commerce applications.

It is a further objection of the present invention in which the individual trainer or professional can acquire their own web application for selling products and have control and provide private label products.

It is still an object of the present invention whereby individualized health care providers can host their own client website providing product information and the like.

Moreover, the present invention is specifically directed to a system whereby a plurality of marketing representatives can set up accounts for fitness retail stores, fitness trainers, chiropractors, physicians, pharmacies, health food stores and gyms in which new account may have a different template design according to its industry.

The present invention is further directed to a system in which the health care professional fitness trainer, chiropractor, etc. can sell a private label brand and get a complete background functional website with administration to control his sales.

These and other objects of the present invention will become apparent from the attached summary, detailed description and claims.

### SUMMARY OF THE INVENTION

In accordance with the present invention, a method for providing an end user patient with the ability to purchase health foods and the like pre-approved by the health care provider comprising the following steps:(a) providing a website comprising a virtual storefront created and populated by a health care provider whereby the patient can select and order health related non-prescription ingestibles; (b) facilitating the payment of the ingestibles by the patient according to payment options selected by the health care provider; and (c) facilitating the delivery of the ingestibles to the end user patient according to payment options selected by the health care provider. In a further embodiment, the invention provides for the creation of individualized websites for the sale of vitamins nutriceuticals, etc.

In another embodiment, the invention is a method for providing health care providers with access to a global computer network for the purpose of allowing the health care providers to sell ingestibles such as health foods, nutriceuticals, vitamins and the like to patients to patients: providing a health care provider with an interface to a website whereby health care provider can create a virtual storefront containing health care ingestibles to be offered for sale to the health care provider's patients; and generating an end user interface accessible by the patients which provides specific and displays the health care ingestible products for sale to the patients whereby the patients can order or obtain said products.

### DETAILED DESCRIPTION OF THE PREFERRED EMBODIMENT

The present invention is specifically directed to a comprehensive system for facilitating the creation of virtual online stores and shopping areas whereby health professionals such as chiropractors, physical therapists, trainers, can sell and control the sale and/or distribution of clothing, items of apparel and other merchandise to designated end user patients and the like. Under the teachings of the present invention, individual business can establish web applications for health care providers and professionals

While the present invention is being described in the context of a system for the distribution of health foods, vitamins and related items, it is to be appreciated that the teachings of the present invention are equally applicable to other fields of use and areas in which products and services are to be distributed or sold to a controlled group of individuals. For the purpose of this invention the term health care provider refers to physicians, medical doctors, osteopaths, chiropractors, doctors of optometry, dentists, physical therapists and trainers.

For example, the teachings of the present invention are applicable to such diverse areas as the distribution and sale of various products. In short, the teachings of the present invention are applicable to any situation or application in which an entity needs to define and control the distribution and sale of specified products or services to a specified group of end users.

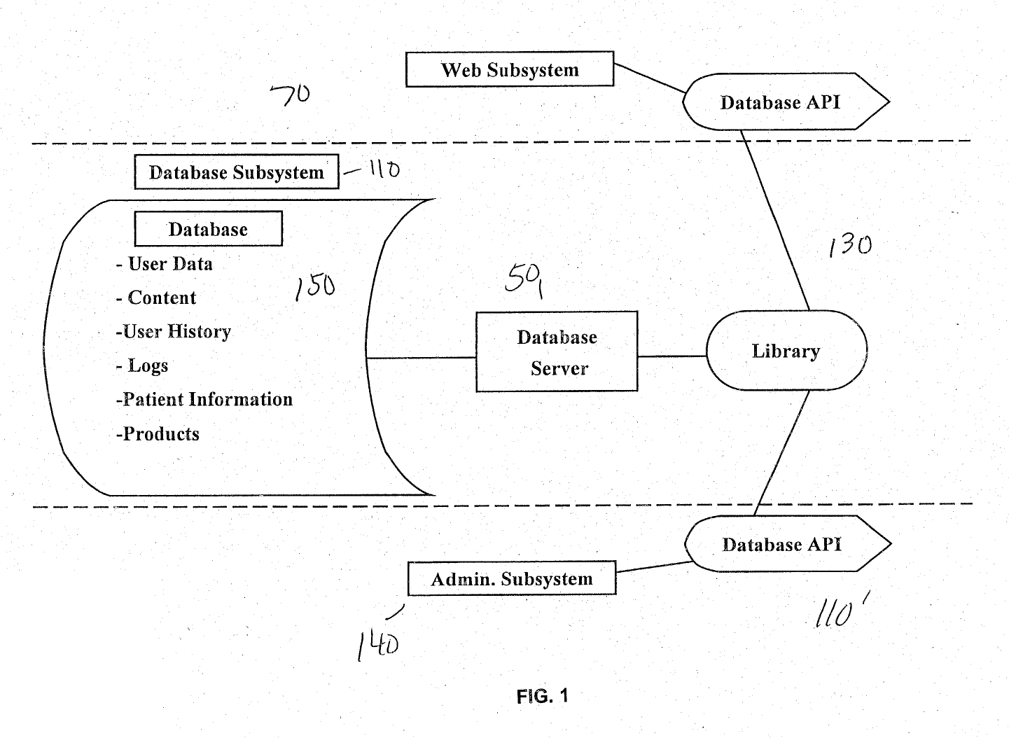

Referring to FIG. 1, a most preferred embodiment of the present invention is disclosed and shown. As will be discussed herein, the present invention in a most preferred embodiment is directed to an online system and technology whereby a health care or related provider is provided with a virtual online store or shopping area to provide health foods, nutriceuticals, vitamins and the like to patients.

As will be discussed in detail herein, in one embodiment, the present invention is directed to a system in which health care providers 16 may create and populate virtual storefronts to be accessed and used by designated member health care providers.

From a structural and operational standpoint, the most preferred embodiment comprises a central computer server 10 connected by a computer network 12 to remote end user stations 14. The central server connects to a database 150. In a preferred embodiment, end user stations 14 comprise a plurality of end user health care providers 16 and patients (hereinafter collectively users) 18 linked via a transport medium 30. As noted, central server in one embodiment contributes a website such as www.sportsone.com which will host a set of virtual websites which control the sale and distribution of products such as health foods, vitamins and nutriceuticals to patients and which facilitate the creation of the virtual online storefronts by the health care providers 16.

Health care providers 6, as noted above, in a most preferred embodiment, will be linked via a global computer network 12 such as the internet or worldwide web, but other embodiments including LANs, WANs and Intranets, fulfill the spirit and scope of the present invention.

Both health care provider and patient systems 16, 18 will typically comprise any device that connects to the system via the internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the worldwide web, local area network (LAN), wide area network (WAN), or any other kind of intranet environment such a standard Ethernet link. In such alternative cases, the end users will communicate with the system using protocols appropriate to the network to which that end user is attached. All such embodiments and equivalents thereof are intended to be within the scope of the present invention.

Referring again to FIG. 1, the present invention may comprise a multi-server 21 environment which comprises a computer system in accordance with the present invention that allows the multiple users 16, 18 to communicate with the system. Through communication link and transport medium 30, health care providers and patients 16, 18 will be linked to the central server 10, preferably by a customizable interface to be described in greater detail below.

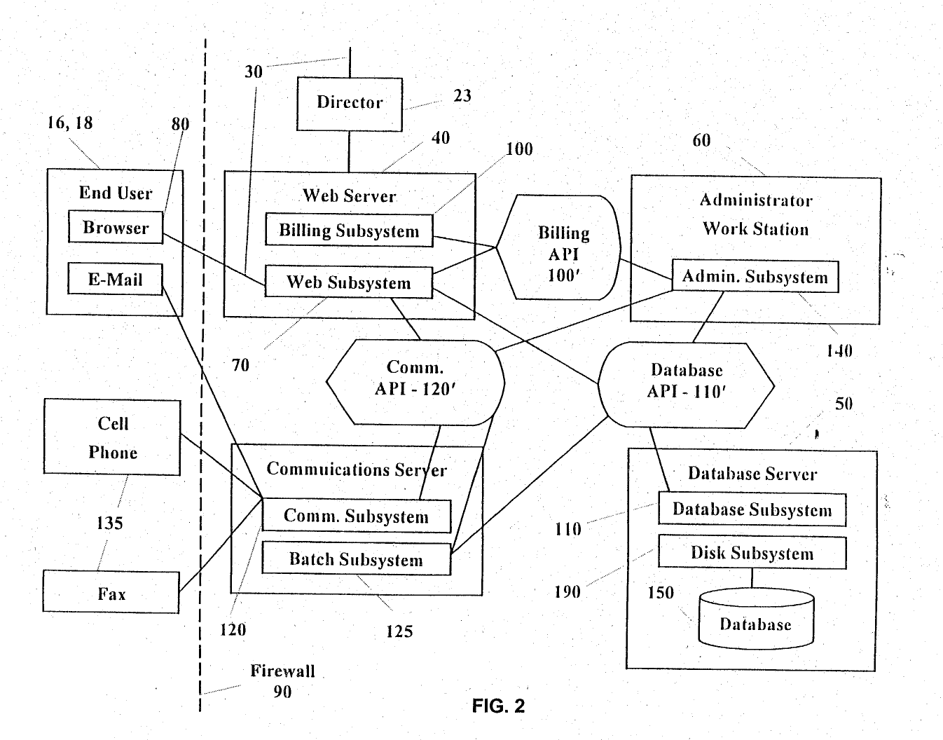

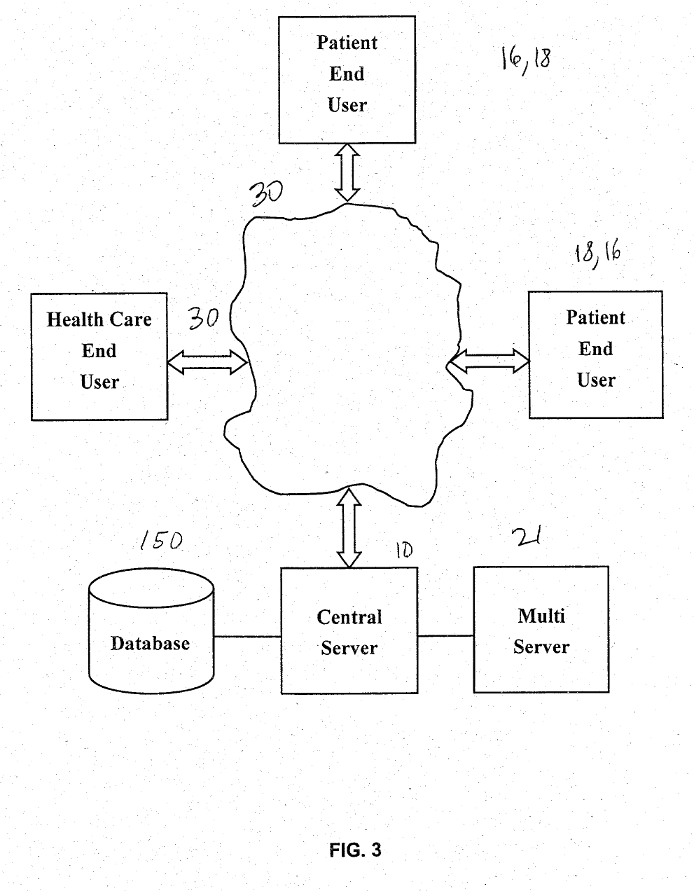

Referring to FIGS. 2 and 3, the central server and database systems of the present invention are now shown and described in greater detail. A local director 23 routes signals through the system to the various servers, to be described below, and to and through transport medium 30 to the health care providers and patients. The system preferably includes two primary servers, a web server 40 and a database server 50 which may operate using such database platforms as SQL server or Oracle. Hence, in one embodiment the SQL server may run SQL server database management software from Microsoft Corporation. Alternatively, the server can further comprise an Oracle database server.

The system further includes an administrative work station 60 or system which provides the administrative capabilities and monitoring for the system under the control of an administrative subsystem 140. The administrative work station 60 allows administrators or other operators to perform routine operations which affect the entire system.

A critical feature of the present invention is that each health care provider may be associated with a central sale representative which assists the health care provider in establish and running his or her site.

Such operations include, but are not limited to, administering the accounts of patients, the ordering and control of inventory, back end functions, adding or deleting new users as health care provider website accounts, the tabulation of printing reports and performing of backups and maintaining the programs that comprise the overall system

A web subsystem 70 is responsible for all interactions with a web browser 80 in the health care provider/patient 16, 18 and serves as the end user interface to the system. All interactions between the devices 16, 18 and the database subsystem occur through the web subsystem 70. Internet Information Server 200 (IIS) by Microsoft Corporation is an exemplary web server software system 70 in accordance with the present invention, although the present invention is in no way limited to this system. The expression of the user interface presented to users 16, 18 in their client devices may be implemented as HTML or other high level computer language or technology, and may be displayed in a standard web browser including a wireless browser.

All systems listed above are preferably communicated via an Ethernet 100 base T network and a switching hub. In addition, a second isolated network segment will preferably exist between the web server 40 and the external communications hardware (e.g. internet router). Such a system will keep external traffic isolated from the internal network, as well as providing a dedicated connection between the web server 40 and the internet for maximum throughput. The systems will have an initial configuration of random access memory for the web server 40 and preferably at least 128 megabits for the database server 50, both having the capability to expand.

The web server 40 is the point of entry to the entire system. The system determines the identity of the health care provider and patient 16, 18 and makes appropriate decisions while serving web pages to the users 16, 18. The web server 40 sends HTML or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation. The Sun Microsystems Solaris is an alternative embodiment. The server typically includes IIS, which is a completely integrated internet application platform. IIS includes a high-performance web server, an application development environment, integrated full-text searching, multi-media streaming and site management tools. The security infrastructure is integrated within the server, thus enabling an easy-to-maintain and highly-secure web development and deployment environment.

The operators of the system may create, delete and update account information by utilizing the administrative subsystem 140 in administrator work station 60. A billing subsystem 100 is responsible for credit card, debit card or checking account verification and any necessary billing type functions.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the internet by a “firewall” 90 which is a safety precaution, and important with respect to the present invention due to the sensitive and confidential nature of some of the material in the database.

In a preferred embodiment, the database subsystem 110 stores all pertinent information pertaining to health care provider and patient accounts, transactions, and account history as well as general dynamic system information. All interactions with the database subsystem 110 are performed through a database API 110′ which may define the interface to a library of stored procedures 130. These are used to implement high-level database functions and to shield the details of the database implementation from the other subsystems. The database subsystem 110 is preferably implemented using database server 50. The database contains such information as user information, the inventory of all items available for sale at the health care provider storefronts, sales history, collections and item descriptions.

The administration subsystem 140 provides an interface for operators and managers of the system to modify the database, print reports, view system data and log user information. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to notify both health care providers and patients 16, 18. Users 16, 18 may be notified by phone, fax, email or pager, or other communications devices which can be contacted by the system 135. Some portable telephones and pagers include email addresses and so may be contacted by the email system; other users have only phone numbers. Other interfaces may be utilized as the application so demands.

A batch subsystem 125 may periodically send out grouped notifications. It will access the database subsystem 110 to determine what notifications are required, and uses the communication subsystem 120 to make those notifications. The billing subsystem 100 may be used to verify and bill credit cards, where applicable, and communicate through the billing API 100′ to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50 logs health care provider and patient setup, account creation information, store inventory, maintains and tabulates transactions and collections, hosts backup operations and performs statistical calculations for the entire system.

The database server 50 is preferably a dual processor computer microprocessor. Each connection to the database 150 and its associated work may be handled by a separate thread within the database server 50 processor space. It is anticipated that a dual processor machine is sufficient for the type and amount of transactions that it will be performing, however if it proves insufficient, the database can be “striped” to two or more machines to distribute the server load.

The disk subsystem 190 of the database server may comprise a vulnerable and crucial server element. Due to the mission critical design of the subsystem, it is preferable to utilize a Level 5 RAID. RAID is an alternative to standard SCSI hard disk drives. A RAID system provides automatic recovery from hard drive failures. Level 5 RAID systems provide the best balance between cost and level of data protection. A Level 5 RAID system uses multiple hard disk drives, on which the stored data is recorded redundantly using a scheme by which the data on the disk can be reconstructed if one of the disk drive units in the RAID fails. In the event of failure, the failed drive can be removed from the RAID system while it is still operating, and a replacement drive can be installed. The RAID system will regenerate the data and return itself to full protection capability. The data sorted on the disk subsystem remains available for normal processing, that is, from the time the drive fails to the time the RAID system is returned to full protection capability. Other levels of RAID which are less costly do not offer this type of data availability and could translate into costly system downtime.

Statistical calculations will be performed by the database server 50, along with other types of report generation. Specifically, IIS can log directly to an Open Database Connectivity (ODBC) standard data source. This makes the availability of the data collected by the database server about client activity on the system more readily available and easier to process into logical reports. Preferably the database server system is configured with a dual P6 CPU, 128 MB ECC, having sufficient ECC RAM, a graphics adapter capable of showing 1024×768 pixels with a depth of 8 bits, a 15 inch monitor, a PCI Fast/Wide SCSI-2 I/O adapter, one PCI 100base T Ethernet adapter, a keyboard and a mouse, a 3.5 inch floppy drive, a CD ROM Drive, a disk drive, a 2 GB PCI Fast/Wide SCSI-2 hard disk drive, two 9 GB PCI Fast/Wide SCSI hard drives (Level 1) or an 8 GB RAID Subsystem (Level 5), and a 24 GB DAT SCSI (2 MB per minute) tape back-up unit.

In one embodiment, there will be one operator workstation 60 used for administering the system. As the need for additional workstations arises, additional operator workstations can be added by adding additional computer systems, installing the administration software and connecting them to the LAN. Operator workstation machines preferably utilize a Windows operating environment manufactured by Microsoft Corporation.

In view of the above operational environment, the present invention is now described in the context of a web-based system for facilitating the creation of an online store and/or ecommerce solution for the sale or health foods, ingestibles, vitamins and the like. The present invention, in a most preferred embodiment, is specifically directed to a dual sided e-commerce solution in which individuals (patients) who desire to purchase health care ingestibles can do so in a health care provider created virtual storefront and/or under the name and direction of the health care provider.

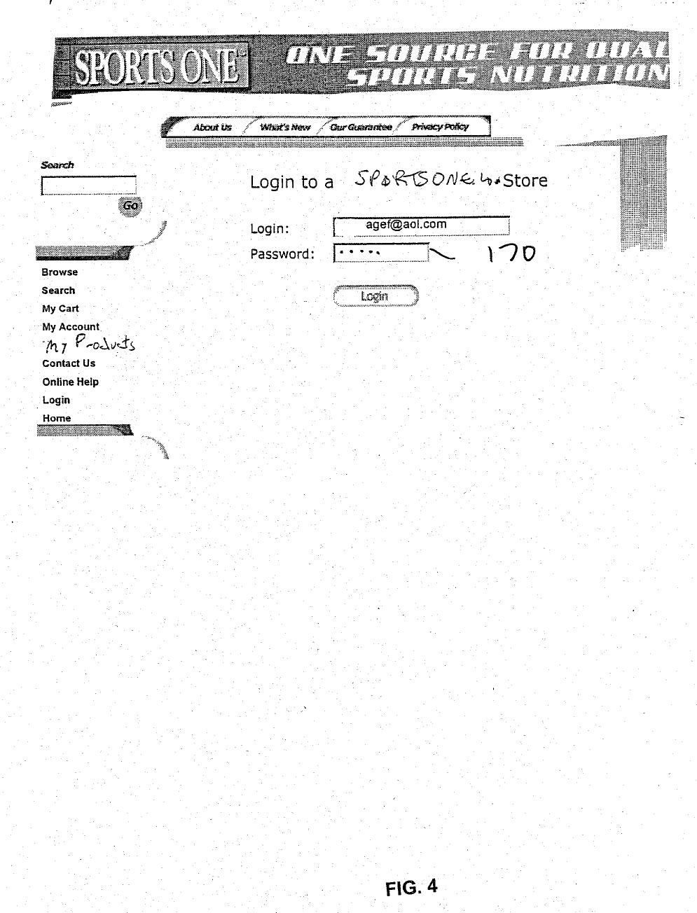

Referring to FIGS. 4 to 8, the patient interface for accessing the technology and obtaining ingestibles shown and described. As shown in FIG. 4, the patient 18 enters the URL store front and is requested to enter a user name and password 170 which may have been provided by the health care provider. The site may include conventional features such as online help and contact information. The patient 18 may be notified by email of his user name and password.

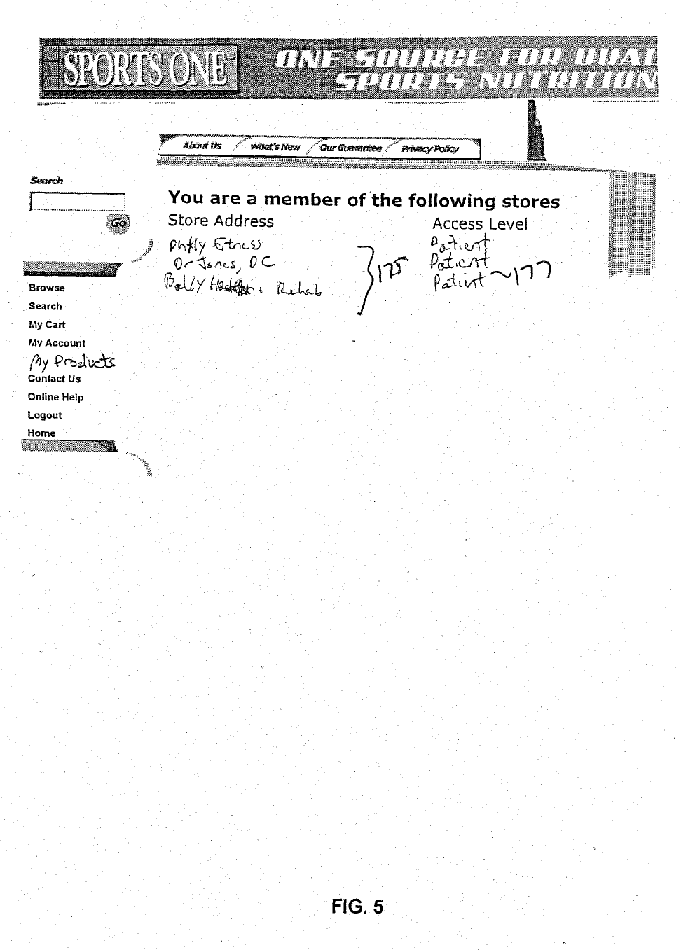

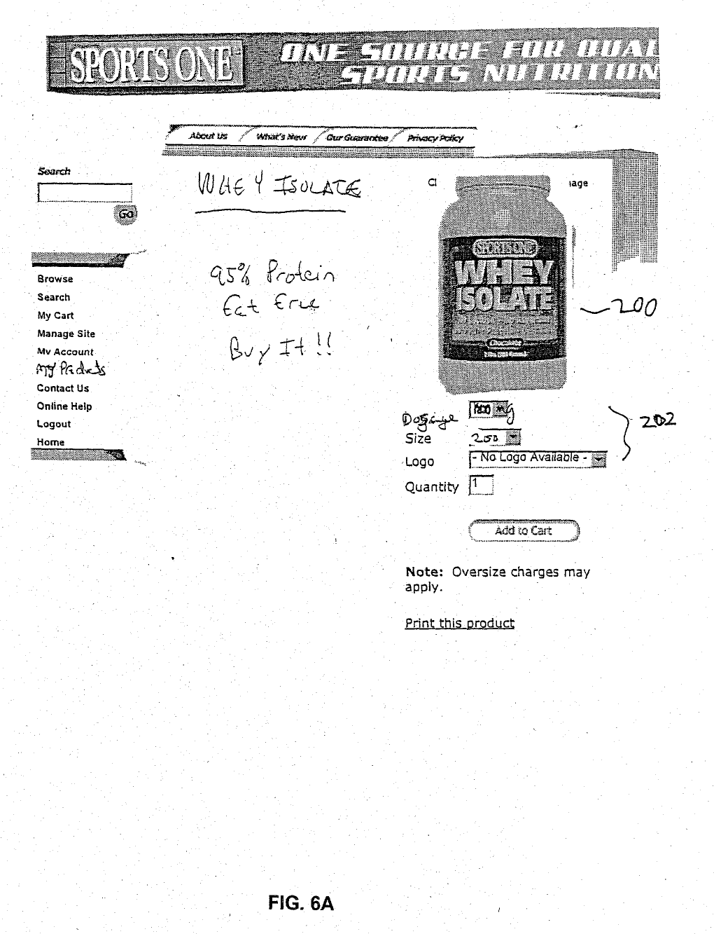

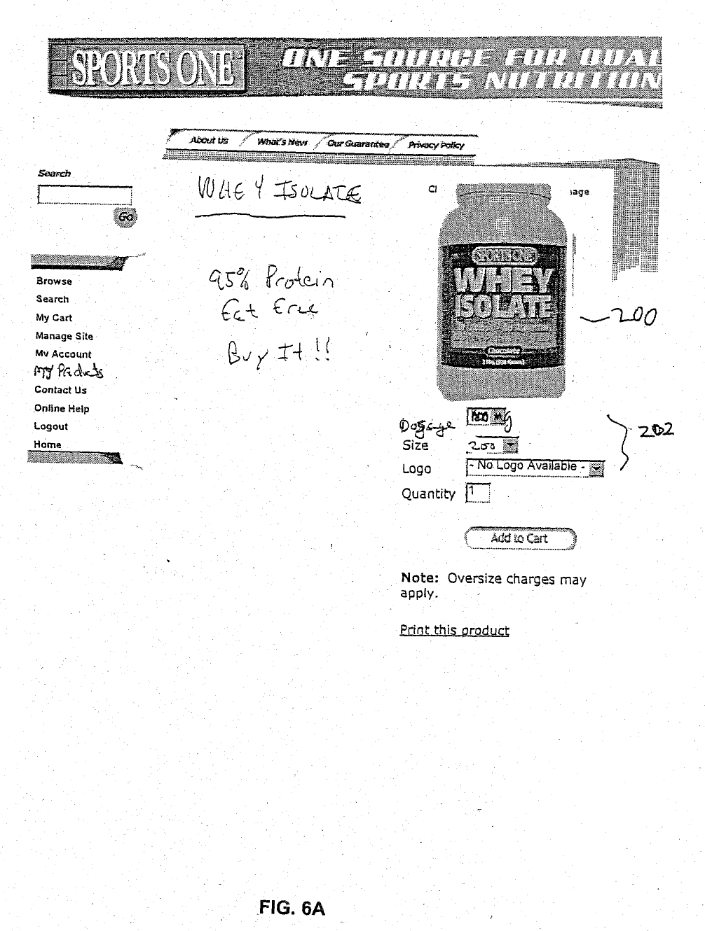

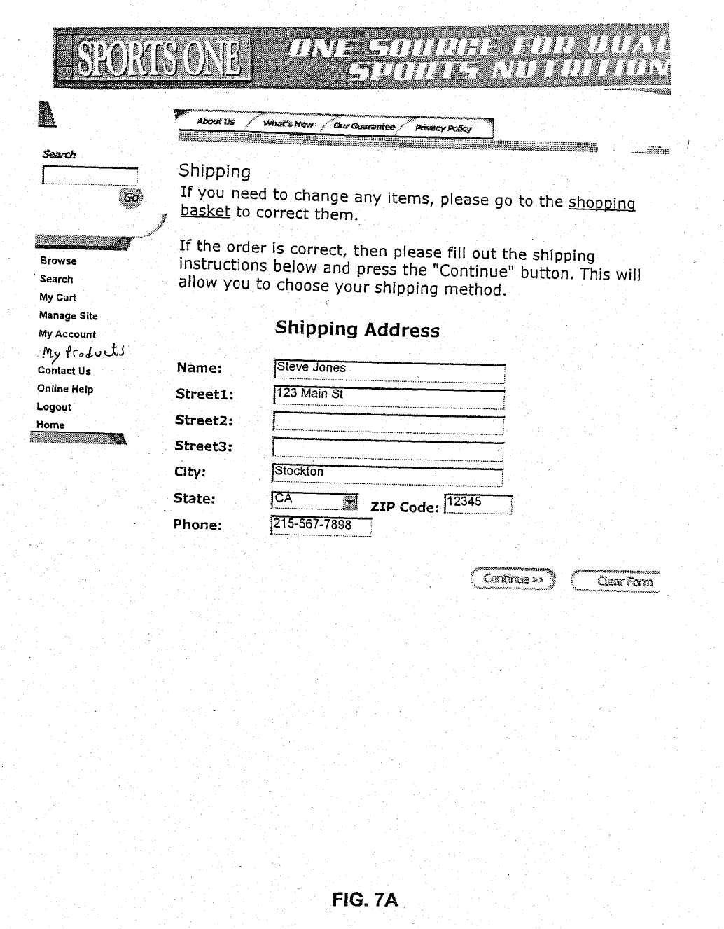

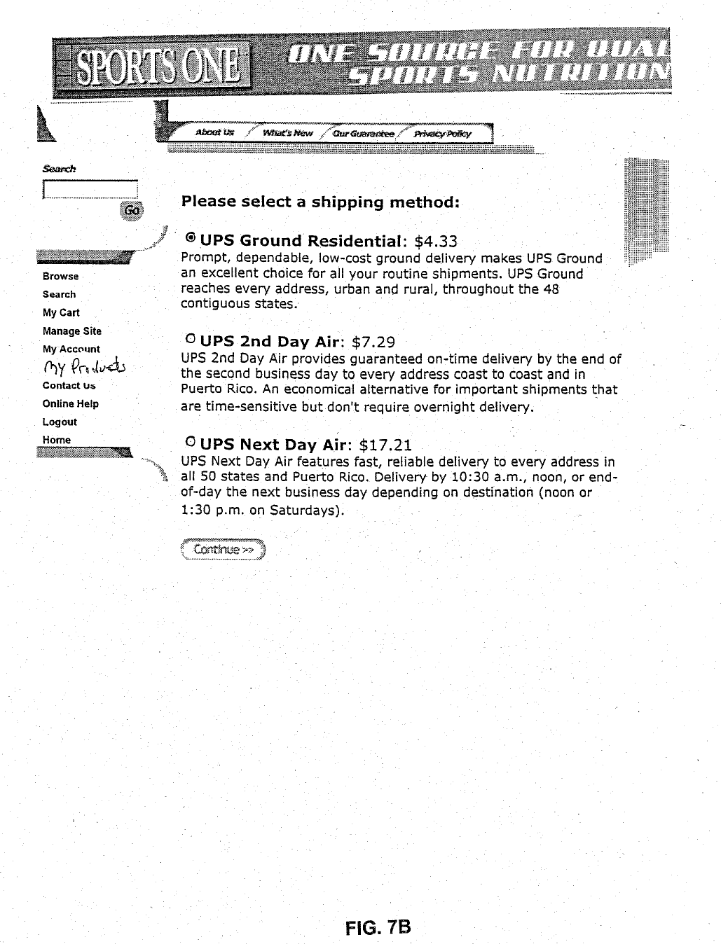

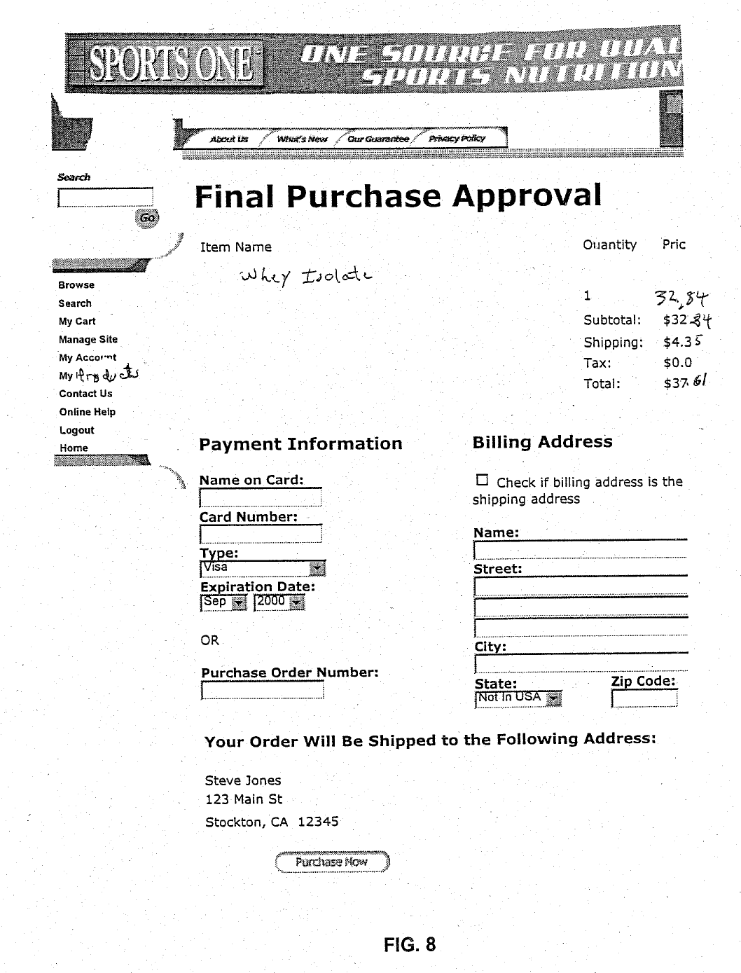

As shown in FIGS. 5-7, the patient 18, after entering his user name and password will be provided with a hyperlink to one or more virtual stores he has access to 175 as well as his level of access 177. The patient 18 will then be directed to several pages of merchandise which he can then purchase or buy. For example as shown in FIG. 6A, the patient 18 may be presented with a nutriceuticals, vitamins and the like 200 in various quantities 202 which he can purchase. If he selects a particular product, it will be added to his shopping cart 220. After selecting his choices as shown in FIG. 6B, the patient 18 is then taken to a check out section where he designates where he wants his product shipped and billed, as shown in FIG. 7A. As shown in FIG. 7B, the patient 18 may be requested to select a shipping option such as UPS Ground Freight. At FIG. 8, the patient 18 will then be taken to a payment section where he will enter credit card information.

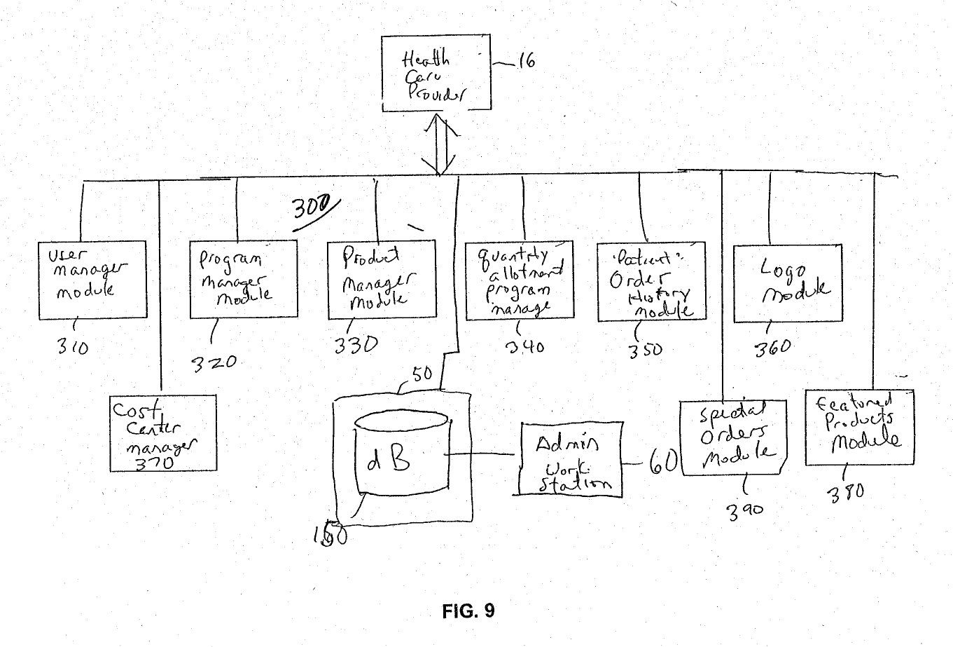

Referring now to FIGS. 9-18, the creation and operation of the online health care provider storefront system of the present invention is now described. While the description of FIGS. 4-8 set forth the mechanism and detail of how products are purchased by patients, FIGS. 9 to 18 illustrate and detail the creation and implementation of the health care provider's electronic commerce solution.

As shown in the block diagram of FIG. 9, the health care provider is provided with a set of modules 300 to create and control its storefront. These modules interface with and may be accessed and edited by the health care provider and are linked to the database 150. These modules include a user manager module 310, program manager module 320, product manager module 330, quantity allotment program manager 340, patient order history module 350, logo module 360, cost center manager 370, featured products module 380 and special order module 390. Each is accessed via an interface accessible by the health care provider 16.

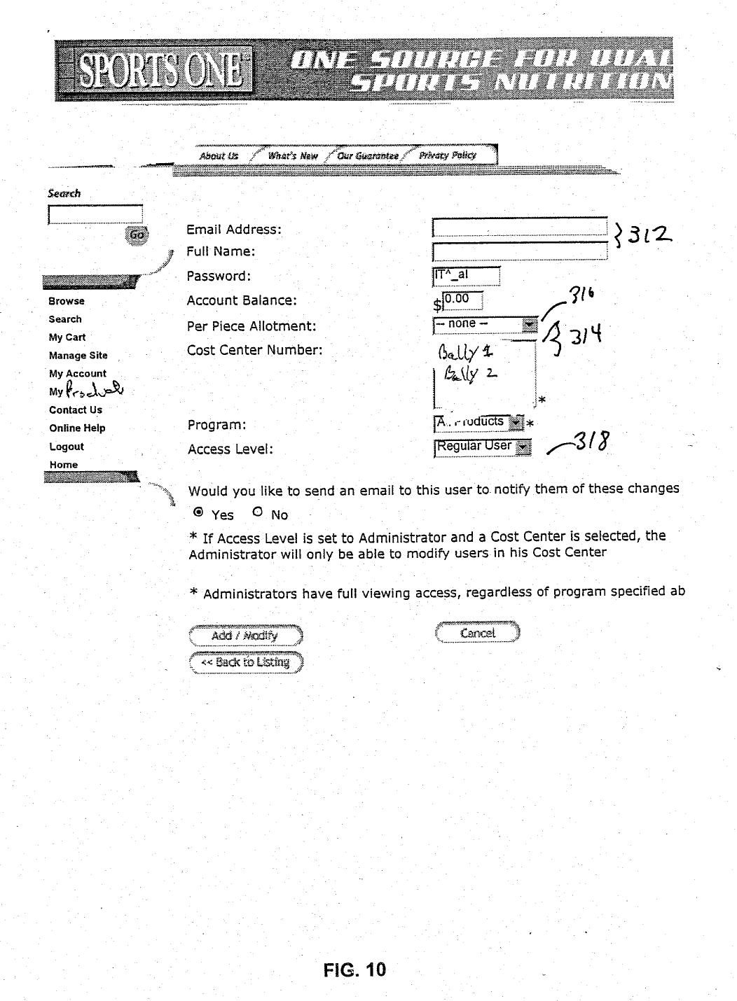

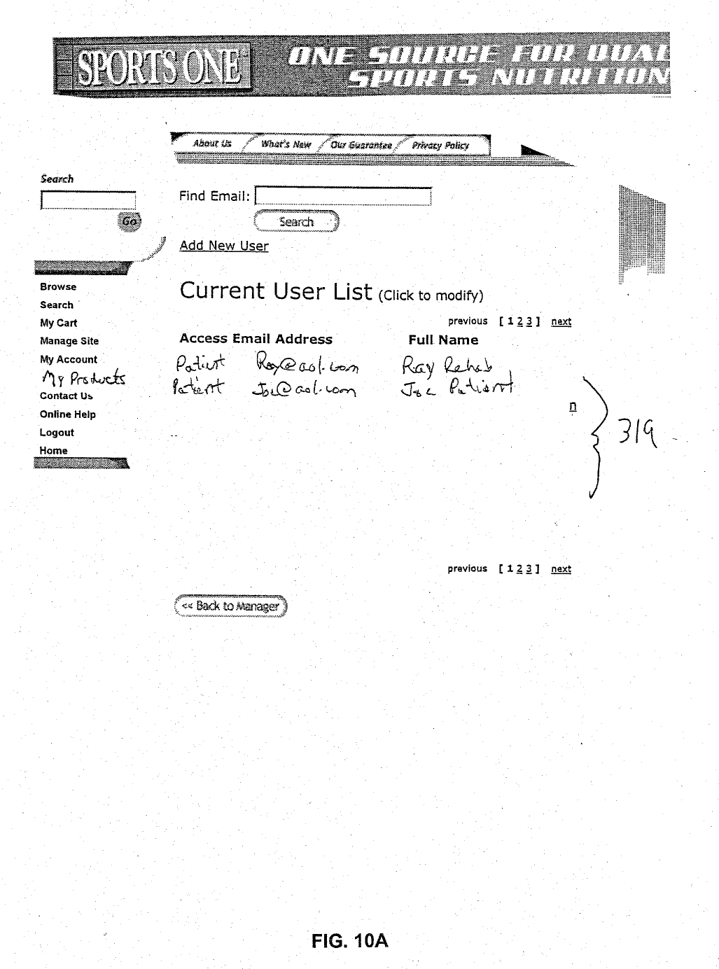

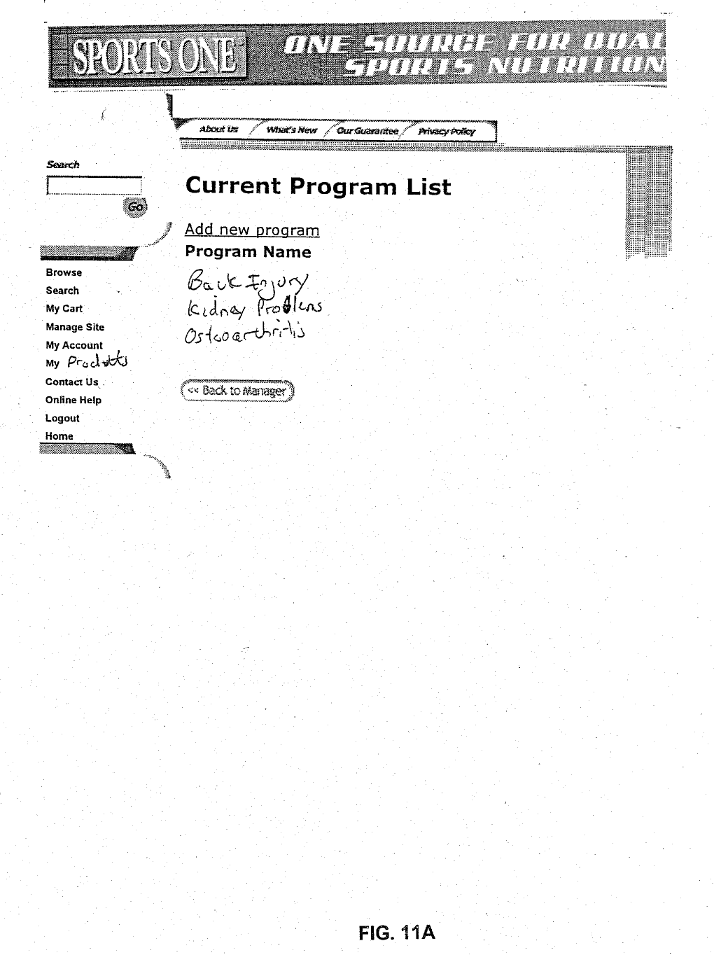

Referring to FIG. 10; the user manager module 310 enables the health care provider 16 to define and set the user parameters of the store. As shown in FIG. 10, the health care provider can define and identify a specific patient end user 16. The patient's email and name can be inputted 312. The patient can further be designated to a specific cost center for accounting purposes 314. For example, some patients may be covered by private insurance or employee or union benefits.

The system further provides for the ability to provide an allotment 316 for the patient as well as the ability to limit the types of products which may be available for purchase by the patient. For example, the health care provider may wish to limit the saleable item of certain patients who have specific health problems whereas other patients may have access to all products within the virtual store. Finally, the level of access 318 available to the patient 18 is designated

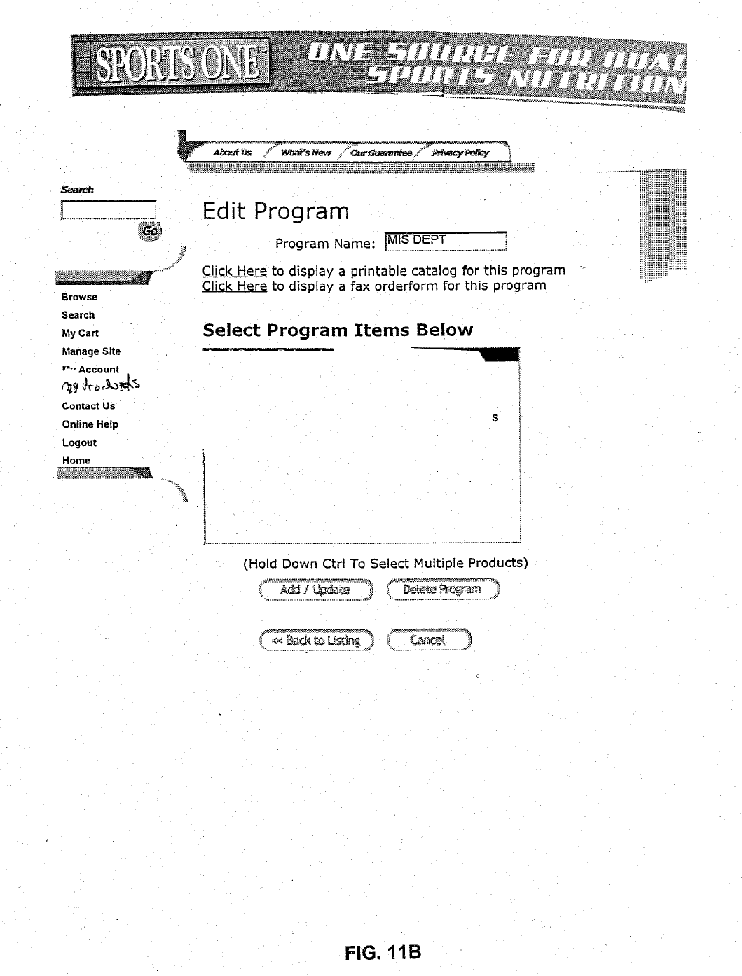

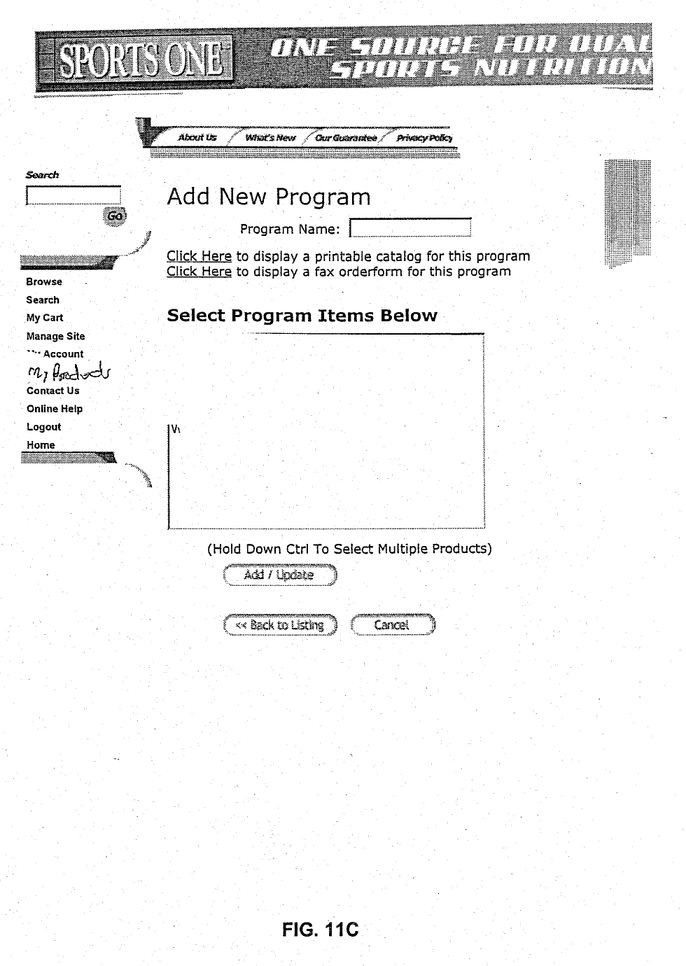

Referring now to FIG. 11, the program manager module 320 is shown and detailed. This enables the health care provider 16 to identify and add the specific products which the health care provider wishes to add to the virtual storefront for various employment groups such as Drivers and the MIS department. For example, the health care provider 16 can create and define a different health care ingestible and add inventory from a list provided by the system to differentiate categories of patients. In this way, the health care provider 16 can rapidly and easily populate the storefront and facilitate ease of use by the patient.

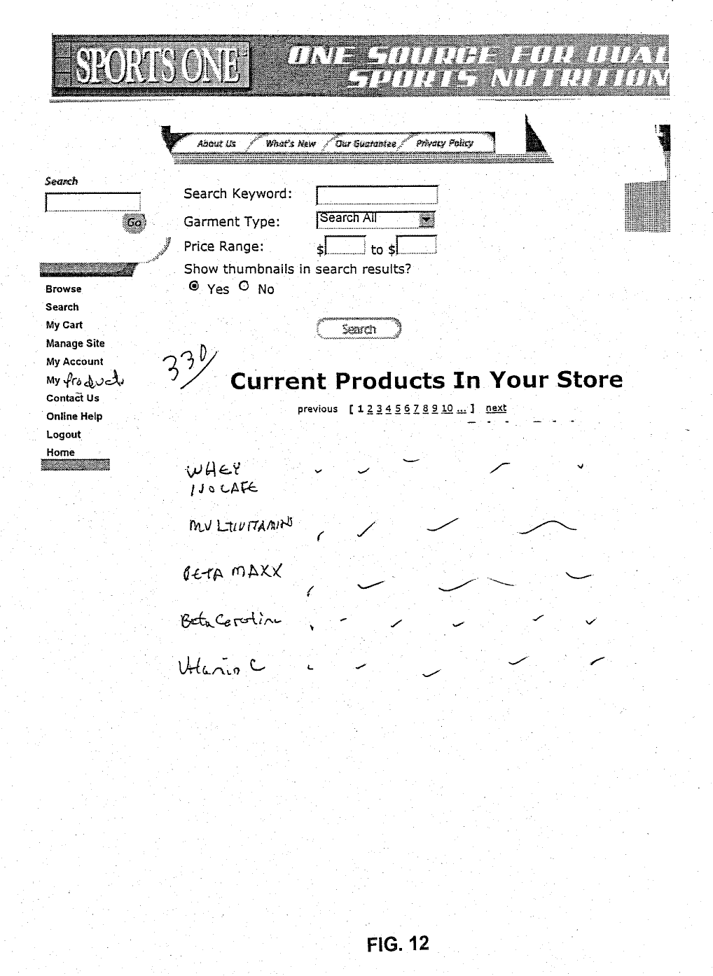

Referring now to FIG. 12, the product manager module 330 is now shown and described. This module allows the health care provider 16 to search and define specific products to be populated in the store. Product types can be defined by type, application, side effects and results.

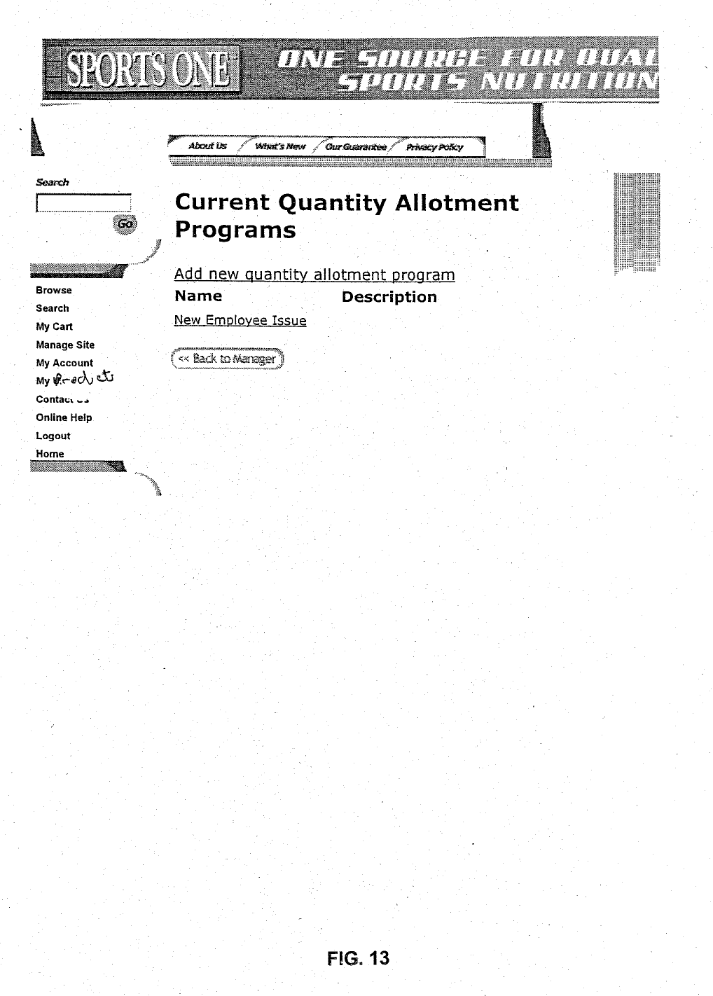

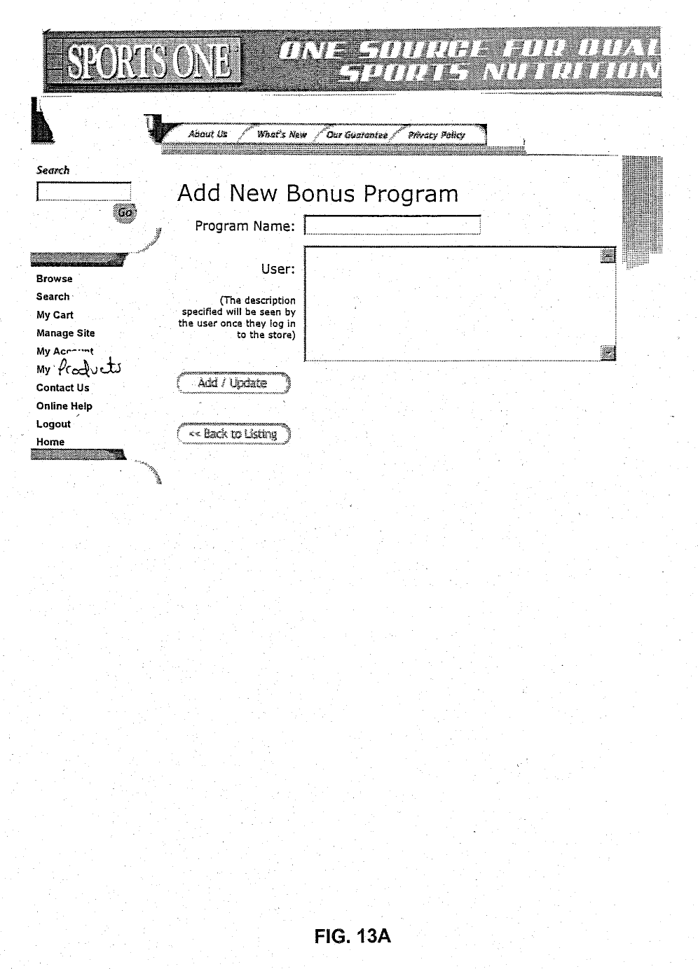

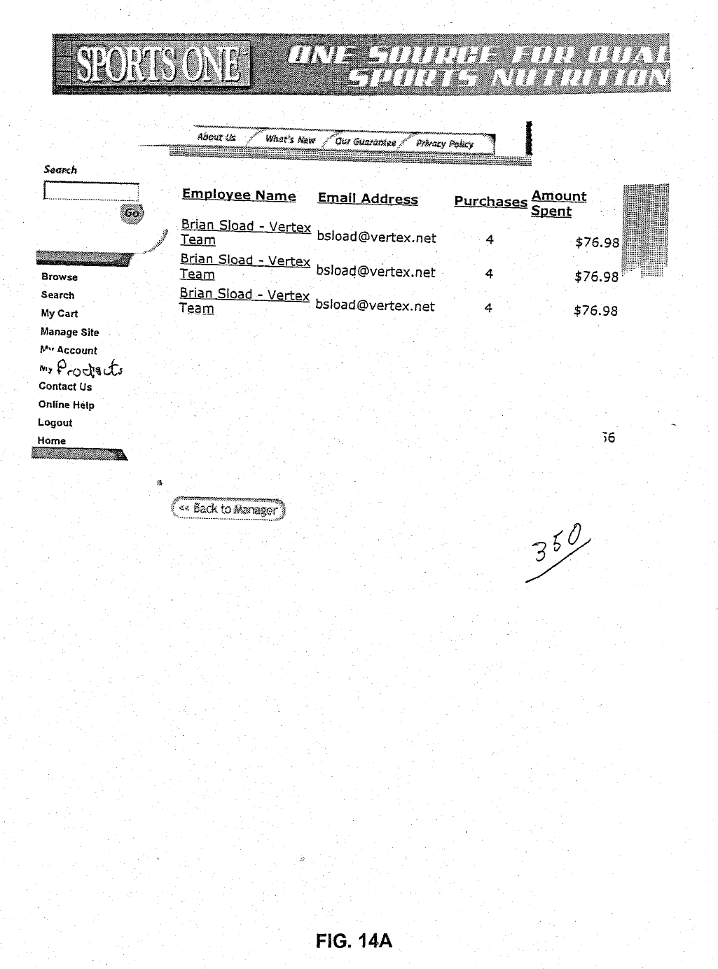

FIGS. 13 and 13A illustrate a quantity allotment program module 340. This module allows the health care provider to provide a written description which will describe new programs for the patient end user. For example, FIG. 13 sets forth the allocation for new patients. This include both dollar allotment. FIGS. 14A and 14B illustrate the patient order history module 350. This module provides a complete breakdown by patient and product of the entire order history of an end user. In this way, the health care provider can maintain complete and accurate historical records of patient purchases. The patient can go over and pay the difference.

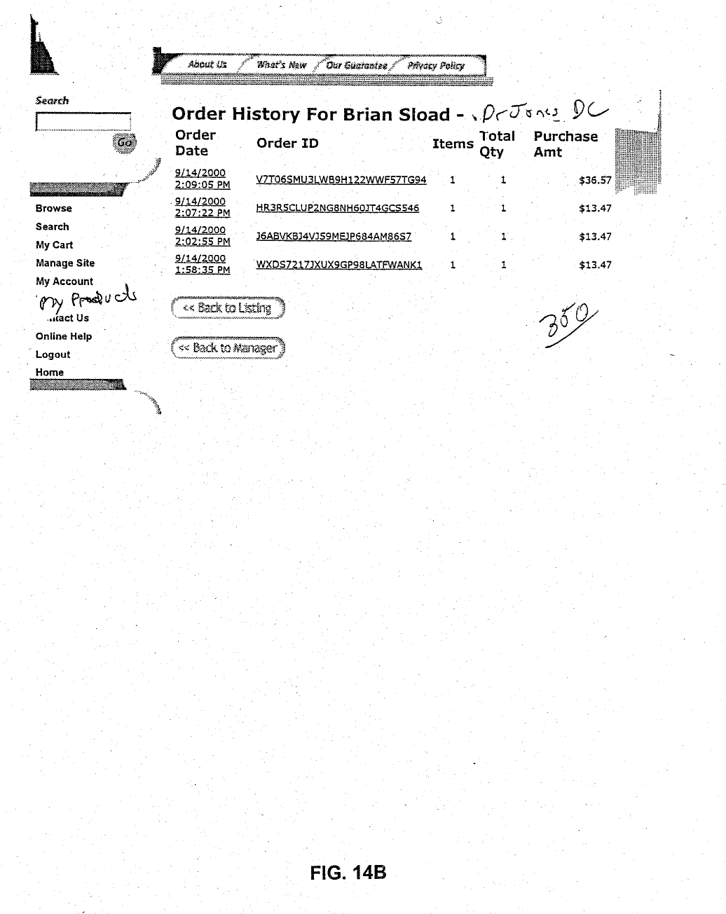

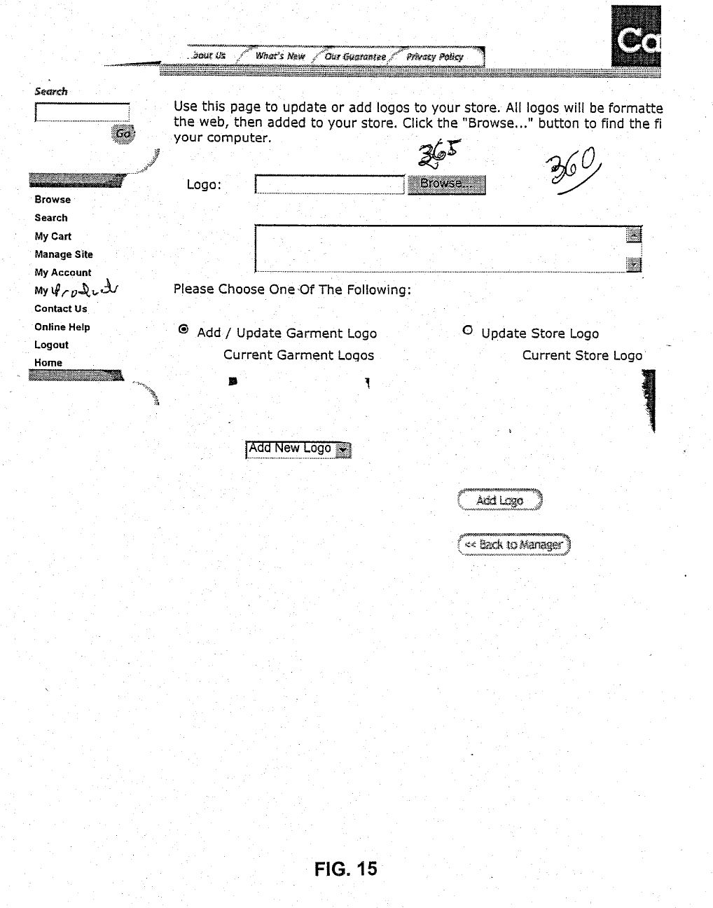

FIG. 15 illustrates the logo module 360. This module enables the health care provider 16 to add a specific logo to the storefront. The system specifically enables the end user administrator to browse his computer end user station 14 and upload a logo 365.

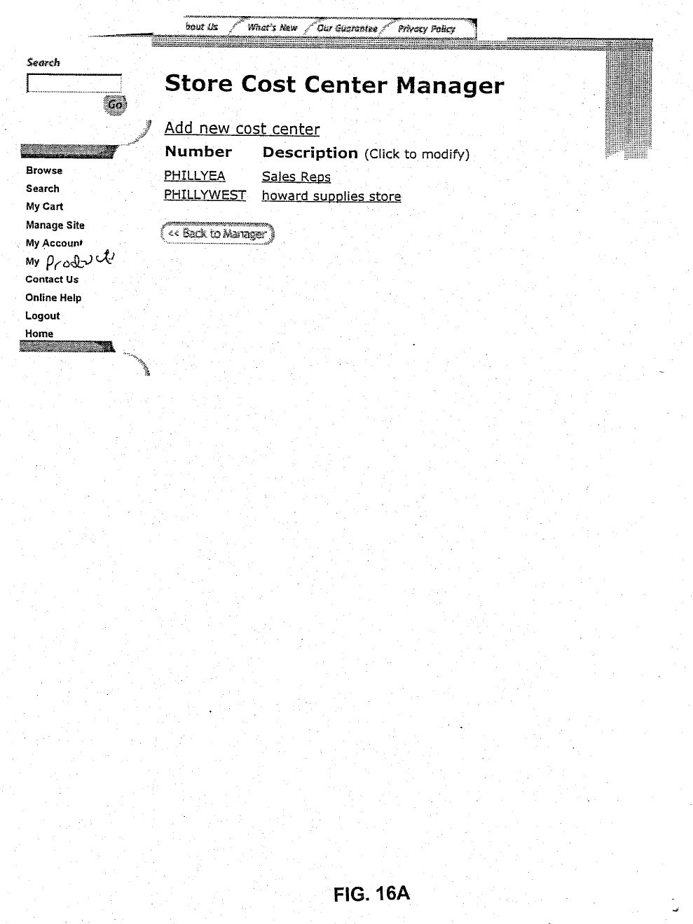

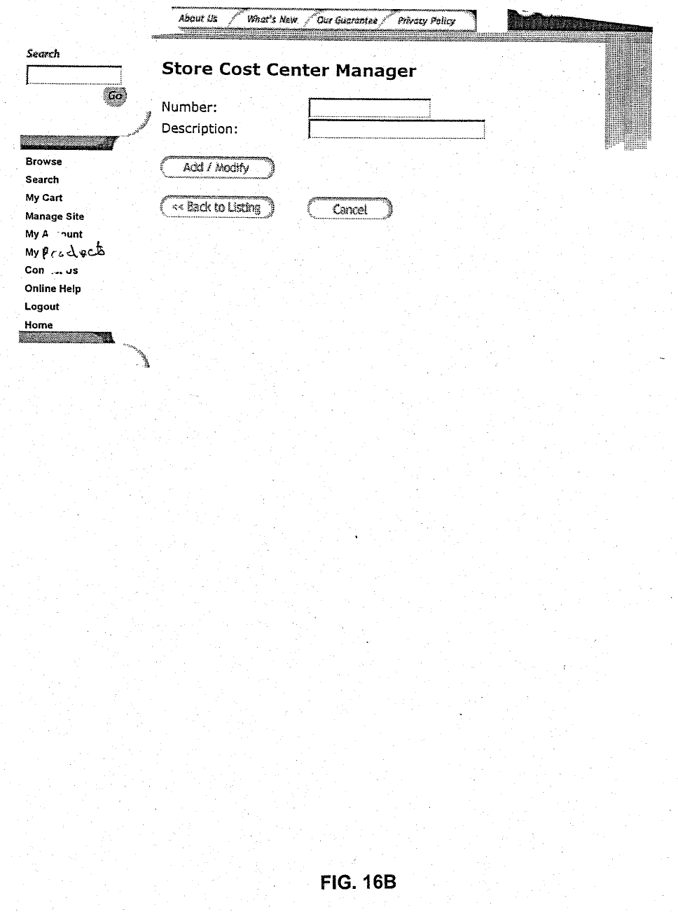

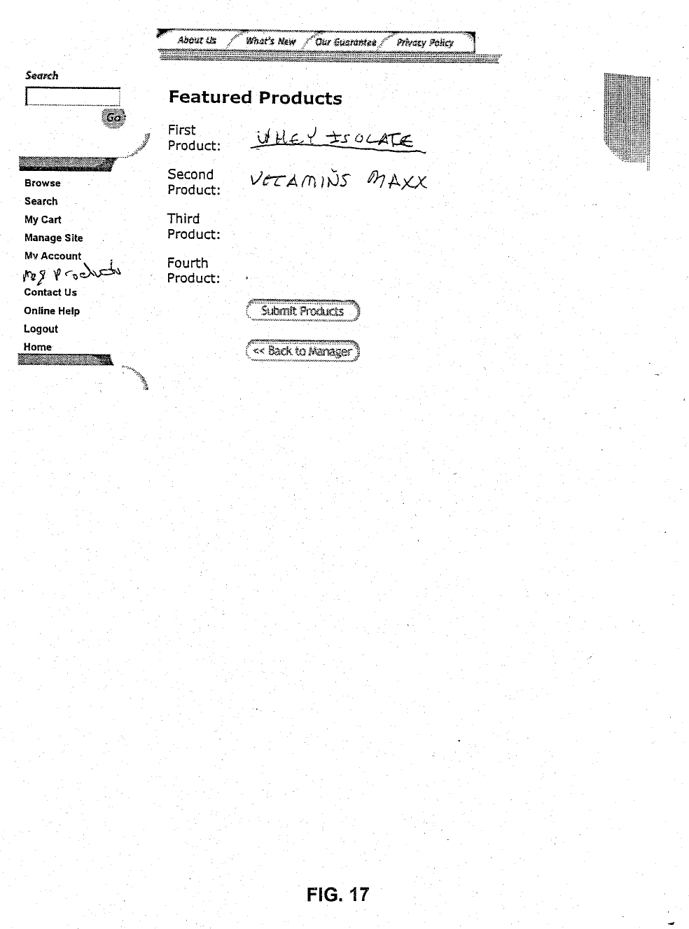

FIGS. 16A and 16B illustrates the cost center manager module 370. This allows the health care provider 16 to define and designate new cost center designations. As noted above, this permits the health care provider to track costs across multiple locations and stores. FIG. 17 illustrates a Feature Products Module 380. This modules permits the health care provider 16 to highlight a plurality of products in the store. Finally, FIG. 18 enables the health care provider to designate special orders.

Specifically, the present invention is designed to handle 24/7 customer service. Each class of customers and representatives are provided in e-biz website that is specifically allocated and designed for their individual needs. For example, a fitness trainer will enroll clients and the client will have his own website featuring products and services and information related to a fitness category. A doctor's patient will get a website of their own and get products.

All websites would contain a product link that breaks down by category of product and then name of product. If the user desires to ask about a product, the representative will click on the product and get all the information to read to the caller about the product including size, nutritional information, servings, flavors, product benefits.

In short, the end user patient receives information provided from a central website. The medical practitioner, chiropractor, health food specialist, nutritionist, or therapist is able to track all sales.

The present invention thus provides a comprehensive online system whereby health care providers can create and populate virtual storefronts to supply or sell patient with. The present invention has been described with reference to the above detailed description and attached Figures. It is to be appreciated that the true nature and scope of the present invention is to be determined with reference to the claims appended hereto.

1. A method for providing an end user patient with the ability to purchase health foods and the like pre-approved by the health care provider comprising the following steps:
(a) providing a website comprising a virtual storefront created and populated by a health care provider whereby the patient can select and order health related non-prescription ingestibles;
(b) facilitating the payment of the ingestibles by the patient according to payment options selected by the health care provider; and
(c) facilitating the delivery of the ingestibles to the end user patient according to payment options selected by the health care provider.

2. The method of claim 1 wherein the health care provider can track the order history of the patient.

3. The method of claim 1 wherein the health care provider can provide a first set of ingestible options to a first set of patients and a second set of selection options to a second set of patients

4. A method for providing health care providers with access to a global computer network for the purpose of allowing the health care providers to sell ingestibles such as health foods, nutriceuticals, vitamins and the like to patients to patients:
providing a health care provider with an interface to a website whereby health care provider can create a virtual storefront containing health care ingestibles to be offered for sale to the health care provider's patients; and
generating an end user interface accessible by the patients which provides specific and displays the health care ingestible products for sale to the patients whereby the patients can order or obtain said products.
